(19) United States
(12) Patent Application Publication
(10) Pub. No.: US 2020/0361285 A1
(43) Pub. Date: Nov. 19, 2020

(54) AIR CONDITIONING UNIT AND SYSTEM FOR VEHICLE

(71) Applicants: Hyundai Motor Company, Seoul (KR); Kia Motors Corporation, Seoul (KR)

(72) Inventor: Gee Young Shin, Suwon (KR)

(21) Appl. No.: 16/653,445

(22) Filed: Oct. 15, 2019

(30) Foreign Application Priority Data
May 13, 2019 (KR) 10-2019-0055684

(51) Int. Cl. B60H 1/00

(52) U.S. Cl. CPC B60H 1/00842; B60H 1/00564

(57) ABSTRACT

An air conditioning unit for a vehicle includes: a first channel having a first inlet and a first outlet, and having a first blower fan and a heating core therein; a second channel having a second inlet and a second outlet, and having a second blower fan and a cooling core therein; a bypass channel diverging from the second outlet of the second channel and connected with the first inlet of the first channel; and a control door disposed between the bypass channel and the first channel and selectively closing the bypass channel or the first inlet such that the first channel and the second channel are disconnected when the bypass channel is closed, and interior air is introduced through the second inlet and the second outlet and then discharged to the exterior through the first outlet when the first inlet is closed.

### CROSS-REFERENCE TO RELATED APPLICATION

This application claims under 35 U.S.C. § 119(a) the benefit of Korean Patent Application No. 10-2019-0055684, filed on May 13, 2019 in the Korean Intellectual Property Office, the entire contents of which are incorporated herein by reference.

### BACKGROUND

### 1. Technical Field

The present disclosure relates to an air conditioning unit and system for a vehicle, the unit and system configured to provide a pleasant temperature environment for passengers by suctioning air in an interior of a vehicle, cooling the air, and then discharging the air back to the interior of the vehicle.

### 2. Description of the Related Art

In general, vehicles are equipped with an air conditioning unit. The air conditioning unit typically includes a heating core, a cooling core, a blower fan, etc., and heats or cools air flowing in the air conditioning unit and then discharges the air to an interior of a vehicle. Accordingly, passengers can control an interior temperature of the vehicle regardless of outside conditions, whereby a pleasant temperature environment for passengers can be provided.

When a vehicle is parked outdoors for a long time at high temperature such as in summer, heat accumulates in an air conditioning unit or a discharge unit connected to the air conditioning unit. In this case, a temperature of the air conditioning unit or the discharge unit increases more than a temperature of the interior of the vehicle. Accordingly, there was a problem in that even though a passenger operates the air conditioning system for cooling, the heat accumulated in the air conditioning unit and the discharge unit is discharged toward the passenger in the early stage of operation, so a pleasant temperature environment is deteriorated.

Therefore, there is a need for an improved automotive air conditioning unit and system for solving this problem.

The description provided above as a related art of the present disclosure is just for helping understanding the background of the present disclosure and should not be construed as being included in the related art known by those skilled in the art.

### SUMMARY

The present disclosure provides an air conditioning unit and system for a vehicle, the unit and system configured to provide a pleasant temperature environment for passengers by introducing air in an interior of a vehicle, cooling the air, and then discharging the air back to the interior of the vehicle.

An air conditioning unit for a vehicle according to the present disclosure may include: a first channel having a first inlet connected with an interior or an exterior of the vehicle, and a first outlet connected with the exterior of the vehicle, and having a first blower fan and a heating core therein; a second channel having a second inlet connected with the interior of the vehicle, and a second outlet connected to the interior of the vehicle, and having a second blower fan and a cooling core therein; a bypass channel diverging from the second outlet of the second channel and connected with the first inlet of the first channel; and a control door disposed between the bypass channel and the first channel and selectively closing the bypass channel or the first inlet such that the first channel and the second channel are disconnected when the bypass channel is closed, and interior air is introduced through the second inlet and the second outlet and then discharged to the exterior through the first outlet when the first inlet is closed.

The heating core may be a condenser, the cooling core may be an evaporator, and the heating core and the cooling core may be connected through a refrigerant line having a compressor and an expansion valve.

The air conditioning unit may be installed on a partition panel.

The air conditioning unit may be installed on a side, which faces a trunk room of the vehicle, of the partition panel.

The first inlet of the first channel may be connected to a trunk room duct that communicates with the trunk room of the vehicle, so air in the trunk room may be introduced into the first channel through the trunk room duct.

The first outlet of the first channel may be connected to a wheel housing duct that communicates with a wheel housing, so air in the first channel may be discharged out of the vehicle through the wheel housing duct.

The second inlet of the second channel may be connected to an introduction duct that communicates with the interior of the vehicle, so air in the interior of the vehicle may be introduced into the second channel through the introduction duct.

The second outlet of the second channel may be connected to a discharge duct that communicates with the interior of the vehicle, so air in the second channel may be discharged into the interior of the vehicle through the discharge duct.

The discharge duct may communicate with a seat cushion, whereby the air in the second channel may be discharged to the seat cushion, or may communicate with a seatback, whereby the air in the second channel may be discharged to the seatback, or may communicate with a roof vent, whereby the air in the second channel may be discharged to the roof vent.

In view of another aspect, an air conditioning system according to the present disclosure may include the air conditioning unit and may further include an integrated controller including a heat sensor that senses internal temperature of the second channel and internal air temperature of the interior of the vehicle, controlling working of the refrigerant line, and controlling operation of the first blower fan, the second blower fan, or the control door.

In a first mode in which cooled air is discharged to the interior of the vehicle, the integrated controller may control working of the refrigerant line, and may control operation of the first blower fan and the second blower fan, and may control the control door to close the bypass channel such that the first channel and the second channel are disconnected.

In a second mode for decreasing internal temperature of the second channel, the integrated controller may control operation of the first blower fan and may control the control door to close the first inlet such that interior air is introduced through the second inlet and the second outlet and then discharged outside through the first outlet.

The integrated controller may implement the second mode only when the internal temperature of the second channel is higher than the internal temperature of the interior of the vehicle by a predetermined temperature or more.

When a difference between the internal temperature of the second channel and the internal temperature of the interior of the vehicle is less than the predetermined temperature, the integrated controller may control working of the refrigerant line, may control operation of the first blower fan and the second blower fan, and may control the control door to close the bypass channel such that the first channel and the second channel are disconnected.

The integrated controller may implement the second mode when the vehicle is started up or the air conditioning unit is turned on.

According to the air conditioning unit and system of the present disclosure, it is possible to improve a pleasant temperature environment for passengers by introducing the air in the interior of a vehicle, cooling the air, and then discharging the air back to the interior of the vehicle.

In particular, there is an advantage in that it is possible to immediately discharge cooled air to the interior of the vehicle even on a sweltering day by removing the heat accumulated in the air conditioning unit or the discharge unit.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a view showing an air conditioning unit for a vehicle according to an embodiment of the present disclosure;

FIG. 2 is a view showing a state when the air conditioning unit according to an embodiment of the present disclosure has been installed on a partition panel;

FIGS. 3 and 4 are views showing a first mode and a second mode of an air conditioning system according to another embodiment of the present disclosure;

FIG. 5 is a conceptual view of an air conditioning unit according to an embodiment of the present disclosure;

FIG. 6 is a side view showing the air conditioning unit according to an embodiment of the present disclosure;

FIG. 7 is a partial conceptual view showing the air conditioning unit according to an embodiment of the present disclosure;

FIG. 8 is a view showing control of the air conditioning system according to another embodiment of the present disclosure; and

FIG. 9 is a view showing an integrated controller of the air conditioning system according to another embodiment of the present disclosure.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

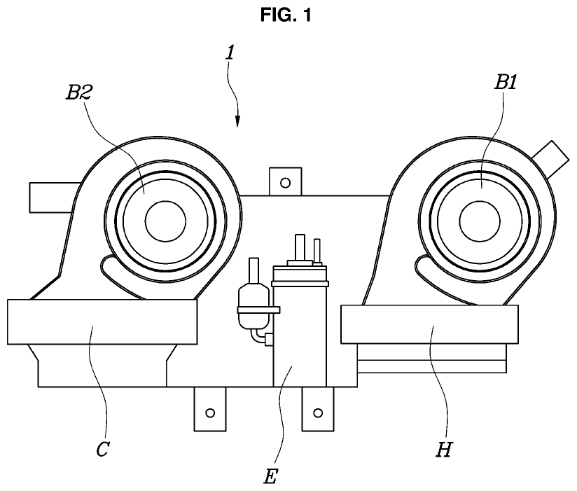

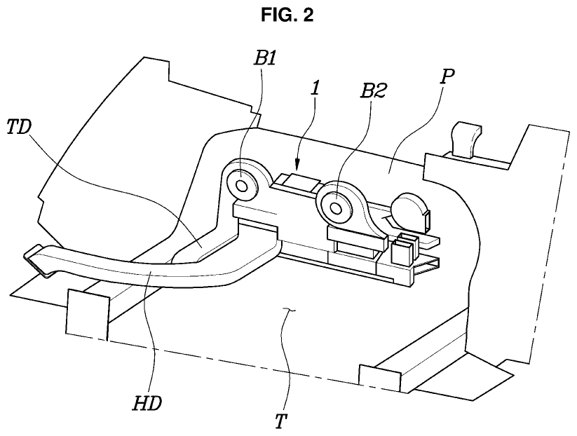

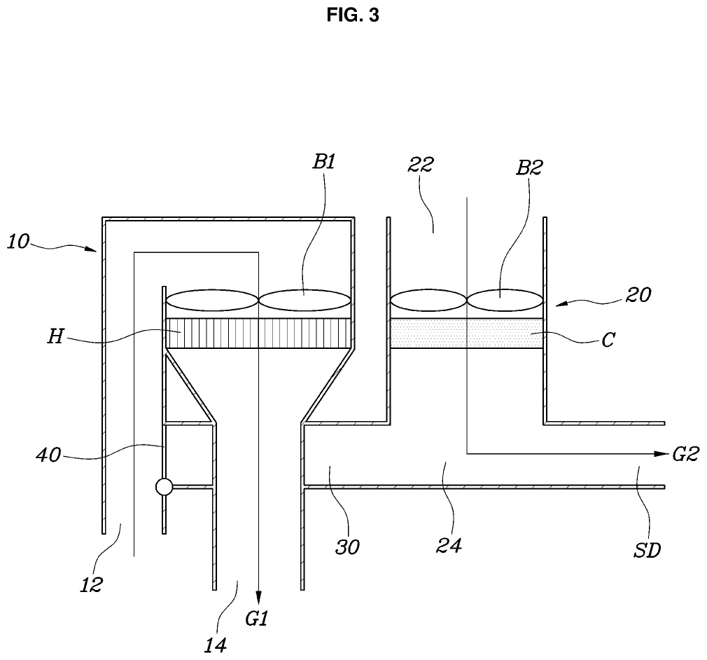

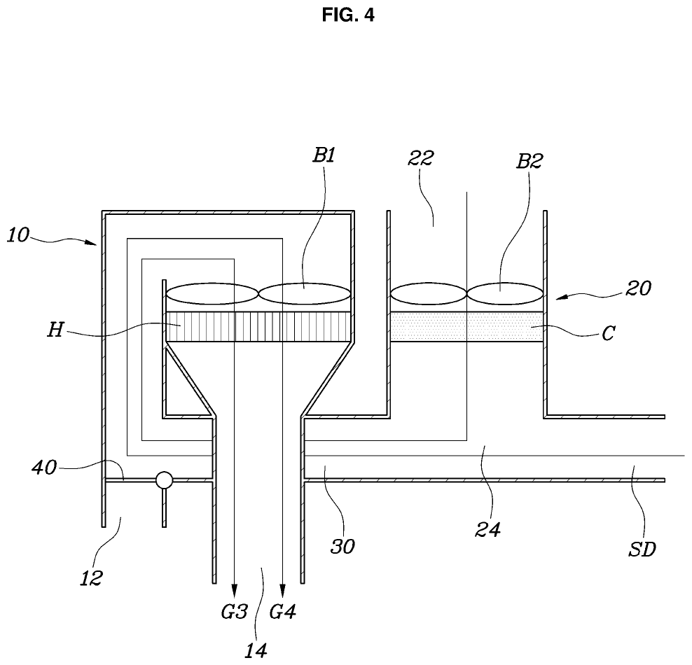

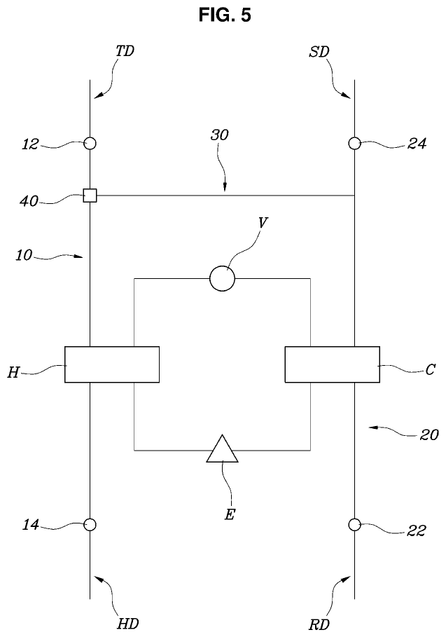

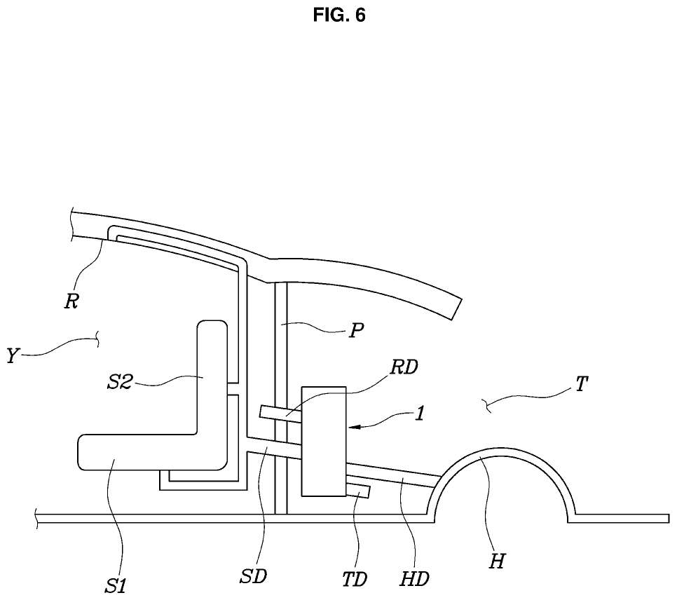

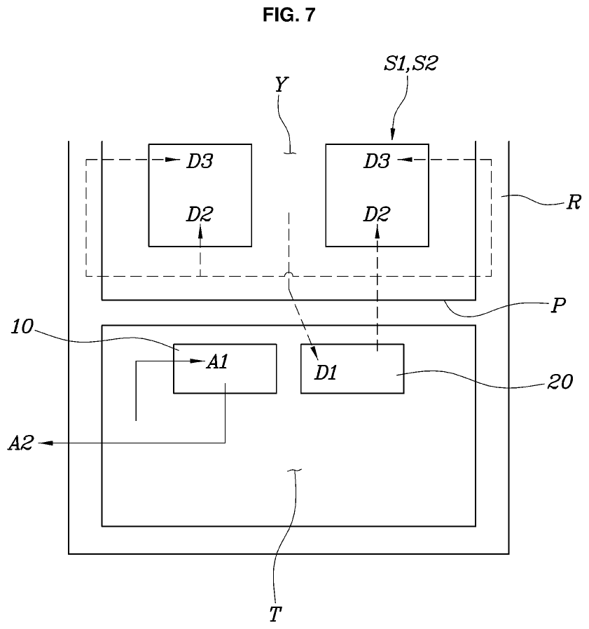

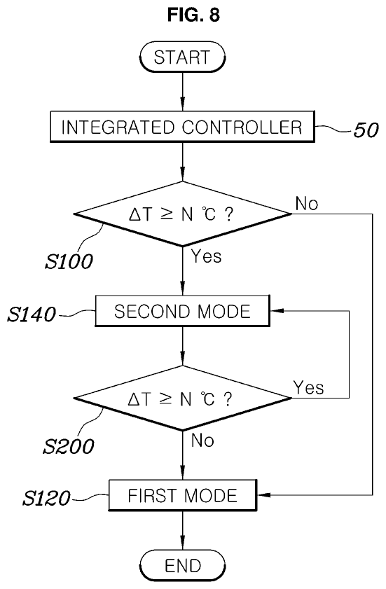

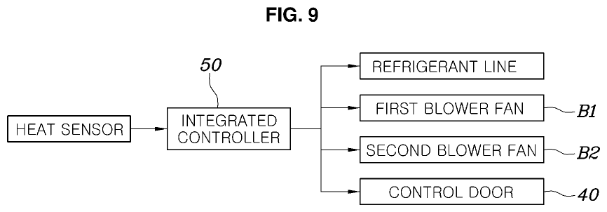

FIG. 1 is a view showing an air conditioning unit for a vehicle according to an embodiment of the present disclosure, FIG. 2 is a view showing a state when the air conditioning unit according to an embodiment of the present disclosure has been installed on a partition panel, FIGS. 3 and 4 are views showing a first mode and a second mode of an air conditioning system according to another embodiment of the present disclosure, FIG. 5 is a conceptual view of an air conditioning unit according to an embodiment of the present disclosure, FIG. 6 is a side view showing the air conditioning unit according to an embodiment of the present disclosure, FIG. 7 is a partial conceptual view showing the air conditioning unit according to an embodiment of the present disclosure, FIG. 8 is a view showing control of the air conditioning system according to another embodiment of the present disclosure, and FIG. 9 is a view showing an integrated controller of the air conditioning system according to another embodiment of the present disclosure.

According to automotive air conditioning units of the related art, when a vehicle is parked outdoors for a long time at high temperature such as in summer, heat accumulates in the air conditioning unit or a discharge unit connected to the air conditioning unit to discharge air, which has passed through the air conditioning unit, to the interior of a vehicle. Accordingly, there was a problem in that even though a passenger uses a cooling function, the heat accumulated in the air conditioning unit and the discharge unit is discharged toward the passenger in the early stage of operation, so a pleasant temperature environment is deteriorated.

As shown in FIGS. 1 to 4, an air conditioning unit 1 for a vehicle according to the present disclosure includes; a first channel 10 having a first inlet 12 connected with an interior or an exterior of the vehicle, and a first outlet 14 connected with the exterior of the vehicle, and having a first blower fan B1 and a heating core H therein; a second channel 20 having a second inlet 22 connected with the interior of the vehicle, and a second outlet 24 connected to the interior of the vehicle, and having a second blower fan B2 and a cooling core C therein; a bypass channel 30 diverging from the second outlet 24 of the second channel 20 and connected with the first inlet 12 of the first channel 10; and a control door 40 disposed between the bypass channel 30 and the first channel 10 and selectively closing the bypass channel 30 or the first inlet 12 such that the first channel 10 and the second channel 20 are disconnected when the bypass channel 30 is closed, and interior air is introduced through the second inlet 22 and the second outlet 24 and then discharged to the exterior through the first outlet 14 when the first inlet 12 is closed.

The first channel 10 is described herein. The first blower fan B1 and the heating core H are disposed in the first channel 10. Referring to FIG. 3, when the first blower fan B1 is rotated, air inside or outside a vehicle is introduced to the heating core H through the first inlet 12. The air that has passed through the heating core H is discharged out of the vehicle through the first outlet 14. Air introduced in the first channel 10 along the path G1 in FIG. 3 is discharged out of the vehicle.

Further, the second channel 20 is described herein. The second blower fan B2 and the cooing core C are disposed in the second channel 20. Referring to FIG. 3, when the second blower fan B2 is rotated, air in the vehicle is introduced to the cooling core C through the second inlet 22. The air that has passed through the cooling core C is discharged into the vehicle through the second outlet 24. Air introduced in the second channel 20 along the path G2 in FIG. 3 is discharged into the vehicle.

Further, the bypass channel 30 is described herein. The bypass channel 30 diverges from the second outlet 24 of the second channel 20 and connects with the first inlet 12 of the first channel 10.

Further, the control door 40 is described herein. The control door 40 is disposed between the bypass channel 30 and the first channel 10 and selectively closes the bypass channel 30 or the first inlet 12. When the control door 40 closes the bypass channel 30, as shown in FIG. 3, the first channel 10 and the second channel 20 are disconnected. In this case, as described above, when the first blower fan B1 and the second blower fan B2 are rotated, air moves along the paths G1 and G2. When the control door 40 closes the first inlet 12, as shown in FIG. 4, the bypass channel 30 opens and the first channel 10 and the second channel 20 are connected. Accordingly, when the control door 40 closes the first inlet 12, as shown in FIG. 4, the interior air of the vehicle is introduced through the second inlet 22 and the second outlet 24 and then discharged to the exterior through the first outlet 14 by operation of the first blower fan B1. Accordingly, since the interior air introduced through the second inlet 22 and the second outlet 24 is discharged to the exterior through the first outlet 14, there is an advantage in that heat accumulated in the second channel 20 is discharged out of the vehicle even if it is summer etc. Thereafter, when a cooling function is used after the heat accumulated in the second channel 20 is discharged, cooled air is discharged to the interior of the vehicle, so there is an advantage in that a pleasant temperature environment for passengers is improved. As shown in FIG. 4, air moves along the paths G3 and G4, whereby the heat accumulated in the second channel 20 is discharged out of the vehicle.

On the other hand, in the present disclosure, as shown in FIG. 5, the heating core H is a condenser, the cooling core C is an evaporator, and the heating core H and the cooling core C can be connected through a refrigerant line having a compressor E and an expansion valve V. A refrigerant circulates through the refrigerant line in a cooling cycle. The compressor makes the refrigerant in a high-temperature and high-pressure gaseous state and sends it to the condenser and the condenser liquefies the high-temperature and high-pressure refrigerant transmitted from the compressor by forcibly cooling the refrigerant using air passing through the first channel Thereafter, the liquid refrigerant that has passed through the condenser rapidly expands through the expansion valve, whereby a low-temperature and low-pressure refrigerant is sent to the evaporator. The refrigerant in the evaporator exchanges heat with air passing through the second channel, so the air passing through the second channel is cooled. The refrigerant is suctioned back into the compressor from the evaporator and repeatedly circulates this process, thereby performing continuous cooling.

On the other hand, as shown in FIGS. 6 and 7, the air conditioning unit 1 of the present disclosure may be installed on a partition panel P. In particular, the air conditioning unit 1 may be installed on the side, which faces a trunk room T of the vehicle, of the partition panel P.

The partition panel P is a separation wall of a car body that divides the interior Y of the vehicle and the trunk room T of the vehicle. The air conditioning unit 1 of the present disclosure is installed on the partition panel P, whereby a separate air conditioning unit for the passengers in the backseat of the vehicle is provided. Further, since the air conditioning unit 1 is installed on the side, which faces a trunk room T of the vehicle, of the partition panel P, the interior Y of the vehicle can be maximally widely secured. That is, there is an advantage in that a separate air conditioning unit for the backseat of the vehicle is provided and the interior Y of the vehicle is maximally widely secured.

On the other hand, as shown in FIGS. 6 and 7, the first inlet 12 of the first channel 10 is connected to a trunk room duct TD that communicates with the trunk room T of the vehicle, so the air in the trunk room T can be introduced into the first channel 10 through the trunk room duct TD. Further, the first outlet 14 of the first channel 10 is connected to a wheel housing duct HD that communicates with a wheel housing H, so the air in the first channel 10 can be discharged out of the vehicle through the wheel housing duct HD.

In this case, the air in the trunk room T is introduced into the first channel 10 through the trunk room duct TD along the path A1 shown in FIG. 7. Further, air with a temperature increased through the heating core H in the first channel 10 is discharged out of the vehicle through the wheel housing duct HD along the path A2 shown in FIG. 7. Since the air with an increased temperature is discharged out of the vehicle, heat does not accumulate in the interior of the vehicle. Alternatively, the first inlet 12 of the first channel 10 may allow air outside the vehicle to be introduced into the first channel 10 through a duct (not shown) that communicates with the wheel housing H.

On the other hand, as shown in FIGS. 5 and 7, the second inlet 22 of the second channel 20 is connected to an introduction duct YD that communicates with the interior Y of the vehicle, so the air in the interior of the vehicle can be introduced into the second channel 20 through the introduction duct YD. Further, the second outlet 24 of the second channel 20 is connected to a discharge duct SD that communicates with the interior Y of the vehicle, so the air in the second channel 20 can be discharged into the interior Y of the vehicle through the discharge duct SD.

In this case, the air in the interior Y of the vehicle is introduced into the second channel 20 through the introduction duct YD along the path D1 shown in FIG. 7. Further, the air cooled through the cooling core C in the second channel 20 is discharged into the interior Y of the vehicle through the discharge duct SD along the paths D2 and D3 shown in FIG. 7. As described above, the air introduced in the interior Y of the vehicle is discharged back into the interior Y of the vehicle, whereby the air in the interior Y of the vehicle recirculates. Accordingly, there is an advantage in that cooling efficiency is increased.

In particular, as shown in FIG. 6, the discharge duct SD communicates with a seat cushion 51, whereby the air in the second channel 20 can be discharged to the seat cushion 51, or communicates with a seatback S2, whereby the air in the second channel 20 can be discharged to the seatback S2, or communicates with a roof vent R, whereby the air in the second channel 20 can be discharged to the roof vent R. In FIG. 7, the path D2 means that cooled air is discharged to the seat cushion 51 and the seatback S2 and the path D3 means that cooled air is discharged to the roof vent R.

As described above, since cooled air is discharged to the seat cushion 51 or the seatback S2, heat accumulating between a passenger and the seat cushion 51 or the seatback S2 when a passenger sits in the seat can be removed. Accordingly, there is an advantage in that the pleasant temperature environment for the passenger is increased. The roof vent R is disposed on a pillar or a head lining, so cooled air is discharged to a passenger from an upper portion in the interior Y of the vehicle. Accordingly, cooled air is sprayed toward the face or the upper body of the passenger, so there is an advantage in that the pleasant temperature environment for the passenger is increased.

Further, as shown in FIGS. 3, 4, 8, and 9, an air conditioning system according to the present disclosure includes an air conditioning unit and further includes an integrated controller 50. The integrated controller 50 includes a heat sensor that senses the internal temperature of the second channel 20 and the internal air temperature of the interior Y of the vehicle, can control working of the refrigerant line, and can control operation of the first blower fan B1, the second blower fan B2, or the control door 40.

The integrated controller 50 includes a heat sensor. The heat sensor senses the internal temperature of the second channel 20 and the internal air temperature of the interior Y of the vehicle. The heat sensor is a concept including both a contact type and a non-contact type. The contact type measures temperature by directly bringing a heat sensor in contact with a measurement target and the non-contact type measures heat radiated from a measurement target. Information about the internal temperature of the second channel 20 and the internal air temperature of the interior Y of the vehicle that are measured in this way is sent to the integrated controller 50. Meanwhile, the integrated controller 50 can control working of the refrigerant line and can control operation of the first blower fan B1, the second blower fan B2, or the control door 40.

In more detail, in a first mode (S120) in which cooled air is discharged to the interior Y of the vehicle, the integrated controller 50 can control working of the refrigerant line, can control operation of the first blower fan B1 and the second blower fan B2, and can control the control door 40 to close the bypass channel 30 such that the first channel 10 and the second channel 20 are disconnected.

Referring to FIGS. 3, 5, and 9, the integrated controller 50 operates the heating core H and the cooling core C by working the refrigerant line and operates the control door 40 to disconnect the first channel 10 and the second channel 20 by closing the bypass channel 30. Further, the first blower fan B1 is operated, whereby air inside or outside the vehicle is introduced into the first channel 10 through the first inlet 12. The air introduced in the first channel 10 increases in temperature by exchanging heat with the refrigerant in the heating core H while passing through the heating core H. The air with increased temperature is discharged out of the vehicle through the first outlet 14 of the first channel 10. In this case, air moves along the path G1 in the first channel 10. Further, the second blower fan B2 is operated, whereby air in the vehicle is introduced into the second channel 20 through the second inlet 22 of the second channel 20. The air introduced in the second channel 20 is cooled by exchanging heat with the refrigerant in the cooling core C while passing through the cooling core C. The cooled air is discharged into the interior Y of the vehicle through the second outlet 24 of the second channel 20. In this case, air moves along the path G2 in the second channel 20.

Further, in a second mode (S140) for decreasing the internal temperature of the second channel 20, the integrated controller 50 can control operation of the first blower fan B1 and can control the control door 40 to close the first inlet 12 such that interior air is introduced through the second inlet 22 and the second outlet 24 and then discharged outside through the first outlet 14.

Referring to FIGS. 4, 5, and 9, the control door 40 opens the bypass channel 30 by closing the first inlet 12. Accordingly, the first channel 10 and the second channel 20 are connected through the bypass channel 30. Further, the first blower fan B1 is rotated, whereby interior air is introduced through the second inlet 22 and the second outlet 24. Referring to FIG. 3, in this case, the interior air introduced through the second inlet 22 is discharged out of the vehicle along the path G3 and the interior air introduced through the second outlet 24 is discharged out of the vehicle along the path G4. Accordingly, the heat accumulated in the second channel 20 is discharged out of the vehicle along the paths G3 and G4. Further, in this case, the heat in the discharge duct SD connected with the second outlet 24 is also discharged. Consequently, there is an advantage in that since the heat accumulated in the second channel 20 has been discharged, cooled air can be immediately discharged to the interior Y of the vehicle when the second mode (S140) is implemented and then the first mode S120 is implemented again.

Further, the integrated controller 50 can implement the second mode (S140) only when the internal temperature of the second channel 20 is higher than the internal temperature of the interior Y of the vehicle by a predetermined temperature (N ° C.) or more, and can implement the first mode (S120) when a difference between the internal temperature of the second channel 20 and the internal temperature of the interior Y of the vehicle is less than the predetermined temperature (N ° C.) (S100).

The integrated controller 50 can implement the second mode (S140) only when the internal temperature of the second channel 20 is higher than the internal temperature of the interior Y of the vehicle by a predetermined temperature (N ° C.) or more. In this case, the internal temperature of the second channel 20 and the internal temperature of the interior Y of the vehicle are measured by the heat sensor. In S100 in FIG. 8, ΔT is internal temperature of second channel−internal temperature of interior of vehicle and N ° C. is the predetermined temperature. Accordingly, the second mode (S140) is implemented when ΔT≥N ° C. (S100). If the difference between the internal temperature of the second channel 20 and the internal temperature of the interior Y of the vehicle is not large, a passenger would not feel largely unpleasant in the early stage of operation even though the first mode (S120) is immediately implemented. Accordingly, the second mode (S140) is implemented only when the internal temperature of the second channel 20 is higher than the internal temperature of the interior Y of the vehicle by a predetermined temperature (N ° C.) or more. The predetermined temperature (N ° C.) may depend on the design of the internal structure of the vehicle and the air conditioning unit.

Referring to FIG. 8, when the difference between the internal temperature of the second channel 20 and the internal temperature of the interior Y of the vehicle becomes less than the predetermined temperature after the second mode S140 is implemented (S100), the integrated controller 50 can control working of the refrigerant line, can control operation of the first blower fan B1 and the second blower fan B2, and can control the control door 40 to close the bypass channel 30 such that the first channel 10 and the second channel 20 are disconnected (S200). As described above, when the difference between the internal temperature of the second channel 20 and the internal temperature of the interior Y of the vehicle becomes less than the predetermined temperature (N ° C.) after the second mode S140 is implemented, the first mode (S120) is implemented. If the internal temperature of the second channel 20 is larger the internal temperature of the interior Y of the vehicle by the predetermined temperature (N ° C.) or more even after the second mode S140 is implemented, the second mode (S140) keeps implemented. In S200 in FIG. 8, ΔT=internal temperature of second channel−internal temperature of interior of vehicle and N ° C.=predetermined temperature. The predetermined temperature (N ° C.) may depend on the design of the internal structure of the vehicle and the air conditioning unit.

Further, the integrated controller 50 of the air conditioning system of the present disclosure may implement the second mode (S140) when the vehicle is started up or the air conditioning unit is turned on. When the vehicle is started up or the air conditioning unit is turned on, the second mode (S140) is immediately implemented, whereby there is an advantage in that cooled air can be immediately discharged when a passenger implements the first mode (S120).

According to the air conditioning unit and system of the present disclosure, it is possible to improve a pleasant temperature environment for passengers by introducing the air in the interior of a vehicle, cooling the air, and then discharging the air back to the interior of the vehicle.

In particular, there is an advantage in that it is possible to immediately discharge cooled air to the interior of a vehicle even on a sweltering day by removing the heat accumulated in the air conditioning unit or the discharge unit.

Although the present disclosure was provided above in relation to specific embodiments shown in the drawings, it will apparent to those skilled in the art that the present disclosure may be changed and modified in various ways without departing from the scope of the present disclosure, which is described in the following claims.

What is claimed is:

1. An air conditioning unit for a vehicle, the air conditioning unit comprising:
a first channel having a first inlet connected with an interior or an exterior of the vehicle, and a first outlet connected with the exterior of the vehicle, and having a first blower fan and a heating core therein;
a second channel having a second inlet connected with the interior of the vehicle, and a second outlet connected to the interior of the vehicle, and having a second blower fan and a cooling core therein;
a bypass channel diverging from the second outlet of the second channel and connected with the first inlet of the first channel; and
a control door disposed between the bypass channel and the first channel and selectively closing the bypass channel or the first inlet such that the first channel and the second channel are disconnected when the bypass channel is closed, and interior air is introduced through the second inlet and the second outlet and then discharged to the exterior through the first outlet when the first inlet is closed.

2. The air conditioning unit of claim 1, wherein the heating core is a condenser, the cooling core is an evaporator, and the heating core and the cooling core are connected through a refrigerant line having a compressor and an expansion valve.

3. The air conditioning unit of claim 1, the air conditioning unit being installed on a partition panel.

4. The air conditioning unit of claim 3, the air conditioning unit being installed on a side, which faces a trunk room of the vehicle, of the partition panel.

5. The air conditioning unit of claim 4, wherein the first inlet of the first channel is connected to a trunk room duct that communicates with the trunk room of the vehicle, so air in the trunk room is introduced into the first channel through the trunk room duct.

6. The air conditioning unit of claim 1, wherein the first outlet of the first channel is connected to a wheel housing duct that communicates with a wheel housing, so air in the first channel is discharged out of the vehicle through the wheel housing duct.

7. The air conditioning unit of claim 1, wherein the second inlet of the second channel is connected to an introduction duct that communicates with the interior of the vehicle, so air in the interior of the vehicle is introduced into the second channel through the introduction duct.

8. The air conditioning unit of claim 1, wherein the second outlet of the second channel is connected to a discharge duct that communicates with the interior of the vehicle, so air in the second channel is discharged into the interior of the vehicle through the discharge duct.

9. The air conditioning unit of claim 8, wherein the discharge duct communicates with a seat cushion, whereby the air in the second channel is discharged to the seat cushion, or communicates with a seatback, whereby the air in the second channel is discharged to the seatback, or communicates with a roof vent, whereby the air in the second channel is discharged to the roof vent.

10. An air conditioning system including the air conditioning unit of claim 2, further comprising an integrated controller including a heat sensor that senses internal temperature of the second channel and internal air temperature of the interior of the vehicle, controlling working of the refrigerant line, and controlling operation of the first blower fan, the second blower fan, or the control door.

11. The air conditioning system of claim 10, wherein in a first mode in which cooled air is discharged to the interior of the vehicle, the integrated controller controls working of the refrigerant line, controls operation of the first blower fan and the second blower fan, and controls the control door to close the bypass channel such that the first channel and the second channel are disconnected.

12. The air conditioning system of claim 10, wherein in a second mode for decreasing internal temperature of the second channel, the integrated controller controls operation of the first blower fan and controls the control door to close the first inlet such that interior air is introduced through the second inlet and the second outlet and then discharged outside through the first outlet.

13. The air conditioning system of claim 12, wherein the integrated controller implements the second mode only when the internal temperature of the second channel is higher than the internal temperature of the interior of the vehicle by a predetermined temperature or more.

14. The air conditioning system of claim 13, wherein when a difference between the internal temperature of the second channel and the internal temperature of the interior of the vehicle is less than the predetermined temperature, the integrated controller controls working of the refrigerant line, controls operation of the first blower fan and the second blower fan, and controls the control door to close the bypass channel such that the first channel and the second channel are disconnected.

15. The air conditioning system of claim 12, wherein the integrated controller implements the second mode when the vehicle is started up or the air conditioning unit is turned on.
